(19) United States
(12) Patent Application Publication
(10) Pub. No.: US 2007/0025385 A1
(43) Pub. Date: Feb. 1, 2007

(54) Residential ethernet node device for transmitting synchronous data using counter and synchronous data transmitting method thereof

(75) Inventors: Jae-Hun Cho, Seoul (KR); Sang-Ho Kim, Hwaseong-si (KR); Yun-Je Oh, Yongin-si (KR); Young-Hun Joo, Yongin-si (KR); Sihai Wang, Suwon-si (KR); Jong-Ho Yoon, Goyang-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/475,619

(22) Filed: Jun. 27, 2006

(30) Foreign Application Priority Data
Jul. 12, 2005 (KR) 2005-62785

(51) Int. Cl. H04L 12/413

(52) U.S. Cl. 370/445

(57) ABSTRACT

A residential Ethernet node device for transmitting synchronous data uses a counter in a residential Ethernet system. The device includes a parser for receiving residential Ethernet data from external other node devices, and parsing the received Ethernet data as synchronous data and asynchronous data. An asynchronous switch switches and transmits the parsed asynchronous data. A synchronous switch switches and transmits the parsed synchronous data. A multiplexer is connected with the asynchronous switch and the synchronous switch, and multiplexes the asynchronous and synchronous data. A synchronous data band assignment unit for, by the count of a counter, indicating synchronous data bandwidth information determined from a synchronous data bandwidth reservation process, and transmitting the indicated bandwidth information to the multiplexer, thereby determining a multiplex position for synchronous data transmission.

### CLAIM OF PRIORITY

This application claims priority under 35 U.S.C. § 119 to an application entitled “Residential Ethernet Node Device For Transmitting Synchronous data Using Counter And Synchronous data Transmitting Method Thereof,” filed in the Korean Intellectual Property Office on Jul. 12, 2005 and assigned Serial No. 2005-62785, the contents of which are incorporated herein by reference.

### BACKGROUND OF THE INVENTION

1. Field of the Invention

The present invention relates generally to a residential Ethernet, and in particular, to a device and method for transmitting synchronous data at each node of a residential Ethernet system.

2. Description of the Related Art

Ethernet is a technology of a local area communication network installed most widely. The Ethernet is now standardized in Institute of Electrical and Electronics Engineers (IEEE) 802.3. However, it had been originally developed by Xerox Corporation, and advanced by Xerox Corporation, DEC Corporation, and Intel Corporation.

Since conventional Ethernet performs competitive access using the carrier sense multiple access/collision detect (CSMA/CD) protocol standardized in the IEEE 802.3, an inter frame gap (IFG) is kept while a service frame of an upper layer is generated and transmitted as an Ethernet frame. Transmission based on a sequence of generation is performed irrespective of a kind of the upper service frame. Ethernet is one of most universal and familiar technologies for transmitting data between terminals different from each other or between several users.

Since the Ethernet performs transmission based on CSMA/CD which performs competitive transmission with the same priority given to all Ethernet frames, it has been known as a technology not suitable to transmission of moving picture or voice data sensitive to transmission time delay.

However, in recent years, with the gradual increase in the time sensitive data and with data transmission being given much weight, methods are proposed for overcoming the drawback caused by transmission delay in order to keep Ethernet as the communication protocol.

One such method provides a classification of service (COS) to data such as multimedia data which should have priority due to its time sensitive nature. Since the according of priority would reduce delay, COS has been proposed as a technology of IEEE 802.3p/q.

However, although the proposed IEEE 802.3p/q technology reduces time delay to some degree in comparison to a conventional IEEE 802.3 Ethernet technology, IEEE 802.3p/q entails overhead. A process for requesting and assigning a transmission band for data does not exist. Instead, a bandwidth manager for managing band assignment is needed, thereby increasing the size of a jitter buffer for bandwidth management.

Another potential alternative is a residential Ethernet which is a method for dividing and transmitting synchronous data and asynchronous data in one transmission cycle. The residential Ethernet is a method for assigning a fixed-sized time slot to the synchronous data and constructing and transmitting a fixed-sized sub synchronous frame.

FIG. 1 is a diagram illustrating an exemplary structure of a transmission cycle in conventional residential Ethernet.

As shown in FIG. 1, in the conventional residential Ethernet, a transmission cycle for data transmission is constructed as one cycle (10) based on a unit of 125 μsec. Each cycle includes an asynchronous frame duration 110 for transmitting asynchronous data and a synchronous frame duration 100 for transmitting synchronous data.

The synchronous frame duration 100 is accorded greater priority than the asynchronous frame duration 110. The synchronous frame duration 100 includes sub synchronous frames 101, 102, 103, each based on 738 bytes, according to a scheme currently under discussion. (Of course, the in-discussion scheme can change).

The asynchronous frame duration 110 for transmitting the asynchronous data includes sub asynchronous frames 111, 112, 113 having variable sizes in corresponding regions.

In conventional residential Ethernet, a constant-sized transmission cycle should be set at each node and the synchronous data should be transmitted within the synchronous frame duration 100 of the transmission cycle. However, to achieve this, the nodes should be mutually time-synchronized.

FIG. 2A exemplifies the node structure in the conventional residential Ethernet system 20. The node structure includes a node 23 for receiving data from a node 21 and a node 22, and a node 24 for receiving data from the node 23.

FIG. 2B exemplifies counting by counters used respectively in each of the nodes 21 to 24.

As shown in FIGS. 2B(a) to 2B(c), each of the nodes 21 to 24 is operated on the basis of its own counter having a limited size. Each counter is operated in synchronization with reference clocks (CLK) different from each other. FIG. 2B(a) pertains to a reference clock of “L” MHz, FIG. 2B(b) pertains to a reference clock of “M” MHz, and FIG. 2B(c) pertains to a reference clock of “L” MHz. In comparing FIG. 2B(a) to FIG. 2B(c), the counting frequencies, i.e., counts per unit of time, are the same; but, due to synchronization differences, the phases may differ. FIGS. 2B(a) and 2B(b) differ both as to counting frequencies and phases.

However, as described above, in the case where the transmission cycle is set identically and the synchronous frame duration 100 is used, there exists potentially a problem of lack of overall management, system-wide, in the case of differing counters for different nodes.

### SUMMARY OF THE INVENTION

In one aspect, the present invention provides a residential Ethernet node device for transmitting synchronous data using a counter, and further provides a method for the transmitting. When a synchronous packet is transmitted at each node in a residential Ethernet system, it is controlled to have a constant cycle at the node, thereby guaranteeing quality of service (QoS) for the synchronous packet and maintaining compatibility with conventional IEEE 802.3.

To achieve the above and other aspects, there is provided a residential Ethernet node device for transmitting synchronous data using the count of a counter in a residential Ethernet system. The device includes a parser for receiving residential Ethernet data from external other node devices, and parsing the received Ethernet data as synchronous data and asynchronous data; an asynchronous switch for switching and transmitting the parsed asynchronous data; a synchronous switch for switching and transmitting the parsed synchronous data; a multiplexer connected with the asynchronous switch and the synchronous switch, and multiplexing the asynchronous data received from the asynchronous switch and the synchronous data received form the synchronous switch; and a synchronous data band assignment unit for, by the count of the counter, indicating synchronous data bandwidth information determined from a synchronous data bandwidth reservation process, and transmitting the indicated bandwidth information to the multiplexer, thereby determining a multiplex position for synchronous data transmission.

In another aspect of the present invention, there is provided a method for transmitting synchronous data using the count of a counter in a residential Ethernet node device of a residential Ethernet system. The method includes a first step of performing a bandwidth reservation process for the synchronous data to be transmitted, for the residential Ethernet node device having the counter; a second step of determining a transmission position of the synchronous data that is inputted using the counter in the residential Ethernet node device; a third step of, upon determination of the transmission position, checking whether or not there are earlier occupied other synchronous data in the determined transmission position; a fourth step of, if it is checked as the check result that there are the earlier occupied other synchronous data, transmitting the inputted synchronous data in a position delayed as much as a position of the other synchronous data; and a fifth step of, if it is checked as the check result that there are not the earlier occupied other synchronous data, transmitting the inputted synchronous data in the determined transmission position.

### BRIEF DESCRIPTION OF THE DRAWINGS

The above and other aspects, features and advantages of the present invention will become more apparent from the following detailed description when taken in conjunction with the accompanying drawings in which the same or similar elements are denoted by the same reference numerals through the several views:

FIG. 1 is a diagram illustrating an exemplary structure of a transmission cycle in a conventional residential Ethernet;

FIGS. 2A and 2B are diagrams illustrating examples associated with a node structure in a conventional residential Ethernet system;

FIG. 3 illustrates a construction of a residential Ethernet node device for transmitting synchronous data using the count of a counter in a residential Ethernet system according to an exemplary embodiment of the present invention;

FIG. 4 illustrates counting intervals utilizable in a residential Ethernet node device for transmitting synchronous data using the count of a counter in a residential Ethernet system according to an exemplary embodiment of the present invention;

FIG. 5 illustrates an example of reservation of synchronous data on a node-by-node basis depending on a method for transmitting synchronous data using the count of a counter in a residential Ethernet system according to an exemplary embodiment of the present invention;

FIG. 6 illustrates a method for transmitting asynchronous data in a method for transmitting synchronous data using the count of a counter in a residential Ethernet system according to an exemplary embodiment of the present invention;

FIG. 7 is a flowchart illustrating a method for transmitting synchronous data using the count of a counter in a residential Ethernet system according to an exemplary embodiment of the present invention; and

FIG. 8 illustrates a method for processing synchronous data having a small transmission bandwidth in a method for transmitting synchronous data using the count of a counter in a residential Ethernet system according to an exemplary embodiment of the present invention.

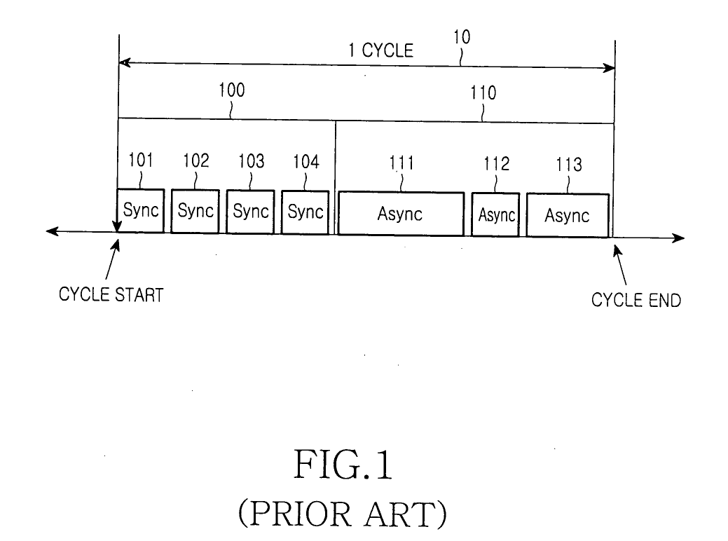

### DETAILED DESCRIPTION

In the discussion to follow, detailed description of known functions and configurations incorporated herein is omitted for clarity and conciseness.

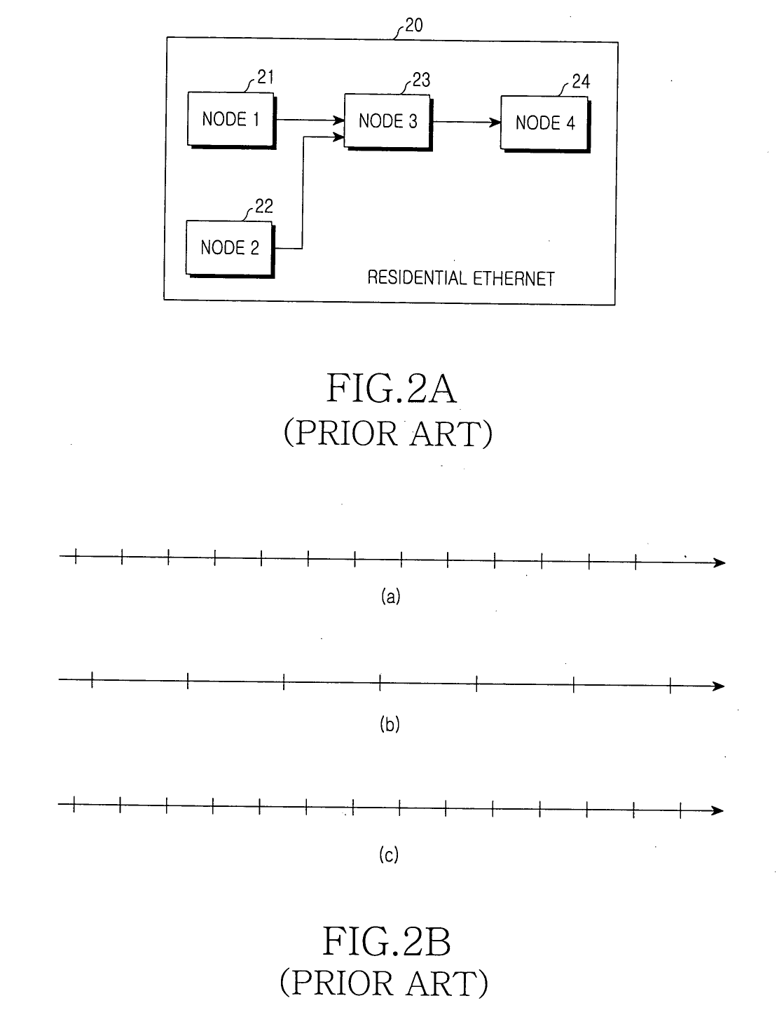

Proposed hereinafter is a synchronous data transmitting device and method that depart from maintaining uniform the format of the transmission cycle at a node, in the case in which, as described above with respect to FIGS. 2A, 2B, the nodes operate on the basis of different counters. Instead, transmission position is determined, on a node-by-node basis, using a counter, for synchronous data that is then accordingly multiplexed into position at the node. In this sense, separate transmissions are made at each node in a residential Ethernet system.

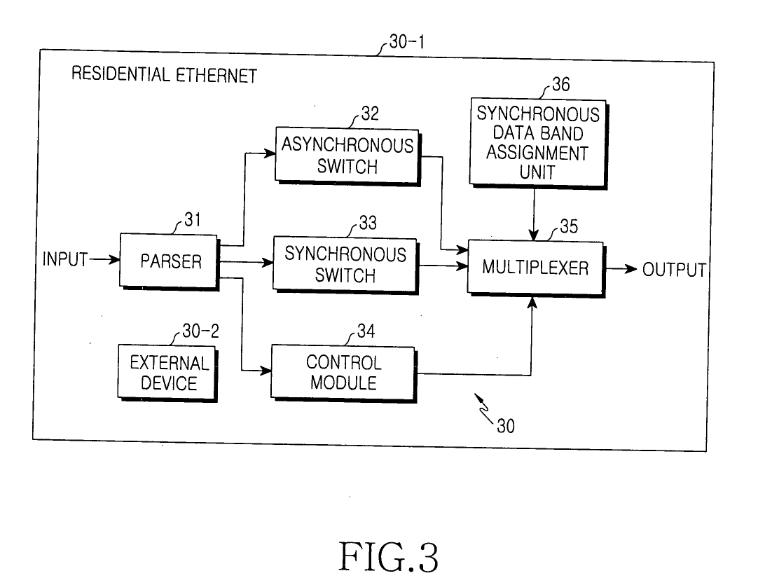

FIG. 3 illustrates, by way of illustrative and non-limitative example, a construction of a residential Ethernet node device 30 for transmitting the synchronous data using the count of a counter in the residential Ethernet system 30-1 according to an exemplary embodiment of the present invention. The residential Ethernet system 30-1 likewise includes external, i.e., other, devices 30-2, which preferably are configured identically with the instant, inventive residential Ethernet node device 30.

Referring to FIG. 3, the inventive residential Ethernet node device 30 includes a parser 31 for receiving residential Ethernet data (that is, multiplexed synchronous data and asynchronous data) from external other node devices 30-2, and parsing the received Ethernet data into synchronous data and asynchronous data. An asynchronous switch 32 switches the parsed asynchronous data. A synchronous switch 33 switches the parsed synchronous data. A multiplexer 35 connected with the asynchronous switch 32 and the synchronous switch 33 multiplexes the received asynchronous data and synchronous data. A synchronous data band assignment unit 36 transmits, to the multiplexer 35, bandwidth information on the received synchronous data. The bandwidth information is determined using a synchronous data bandwidth reservation process in which the unit 36 determines a multiplex position of the received synchronous data.

The inventive residential Ethernet node device 30 further includes a control module 34 for receiving a control signal for use in controlling the current node and transmitting the received control signal to the multiplexer 35. The control signal is parsed, according to need, and outputted from the parser 31 in the case where the residential Ethernet data received, from an external node device 30-2 for example, contains the control signal used for “Time of Day” or “Cycle master.”

Operationally, upon receipt of the residential Ethernet data that is a combination of the synchronous and asynchronous data, the parser 31 parses the received residential Ethernet data into the synchronous data and the asynchronous data, and independently parses, according to need, specific purposed Ethernet data having the control signal used for the “Time of Day” or the “Cycle master.” Here, the distinguishing between synchronous and asynchronous data can be implemented by manipulating a specific portion of a preamble of each of the synchronous data portions and the asynchronous data portions that are parsed from the residential Ethernet data. The distinguishing can, alternatively, be implemented by providing a specific Ethernet type indicative of synchronous data, or by using a header only for the synchronous data.

Among data parsed using the parser 31, the synchronous data is routed and processed in the synchronous switch 33, and the asynchronous data is based on an Ethernet packet structure and therefore, is routed in the commonly used asynchronous switch 32.

The specific purposed Ethernet data, e.g., having control signals, and parsed, according to need, for its proper use in the control module 34, is processed and transmitted in the same manner as the asynchronous data.

The synchronous data band assignment unit 36 operates a counter having a counting interval whose size is determined by the node device 30 at the node. Preferably, the node device 30 has a number of counters, or counting schemes, from which to select the operating counting scheme. The assignment unit 36 determines a size of one-packet synchronous data according to the bandwidth reservation process that was performed before previous synchronous data transmission using the operating counting scheme. The unit 36 uses the counter to designate a position of the respective parsed synchronous data portion. The counter counts on the basis of a reference clock which is “free running” at each node device 30.

Referring again to FIGS. 2A, 2B, the number of counts per unit of time in a Hop shown in FIG. 2B(a), differs from the number of counts per unit of time in a Hop 1 shown in FIG. 2B(b). Also, the counters are not synchronized in phase. In comparing the Hop 0 of FIG. 2B(a) to the Hop 2 of FIG. 2B(c), the reference clock uses the same frequency, and the numbers of times of count, i.e., counts, within a predetermined time period are also the same; but, likewise, the two counters are not time synchronized.

In an exemplary embodiment of the present invention, by contrast, when synchronous data is transmitted, data loss or jitter can be minimized even between the respective node devices 30 using respective counters that differ from one another as to frequency and/or phase.

Data band assignment in the unit 36, according to the present invention, proceeds in the following exemplary fashion. From a transmission of information, the receiving node device 30 determines, using its operating counting scheme, a length in counts of incoming one-packet synchronous data, and an interval to synchronous data of a consecutively adjacent packet.

Once the above-described determinations have been made, the multiplexer 35 multiplexes the synchronous data received from the synchronous switch 33, depending on the outcomes of the determinations. If positioning of the synchronous data has been determined in the manner described above, the multiplexer 35 then multiplexes the asynchronous data received from the asynchronous switch 32 into a position at which the synchronous data does not exist. In other words, asynchronous data is fitted into positions left unoccupied by the synchronous data. The control signal received from the control module 34 is likewise positioned in the same manner as the asynchronous data.

If the synchronous data and the asynchronous data are multiplexed in the multiplexer 35, they are transmitted to a next node device 30-2.

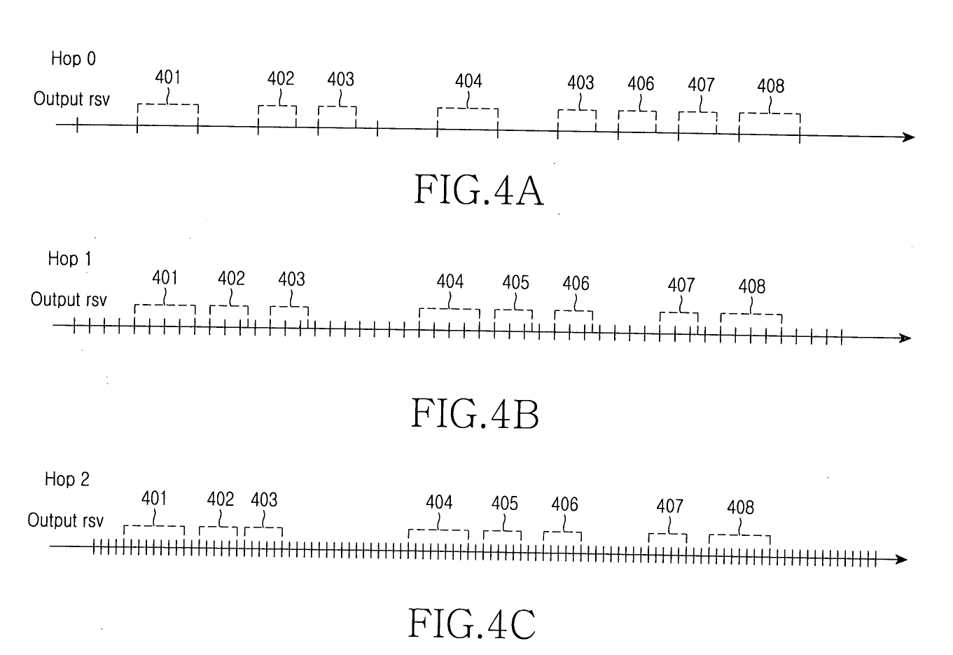

If each node has a different counter value, i.e., counting frequency or phase of the operating counting scheme, as discussed above, the bandwidth is wasted or processing power utilization is increased depending on the counter value, as described below in conjunction with FIG. 4.

FIG. 4 illustrates three exemplary counting schemes in the residential Ethernet node device 30 for transmitting the synchronous data using the count of a counter in the residential Ethernet system 30-1 according to an exemplary embodiment of the present invention.

FIG. 4A exemplifies a case where the number of counts of the counter within a predetermined time period is relatively small. FIG. 4B exemplifies a case where the number of counts of the counter within a predetermined time period is relatively large. FIG. 4C exemplifies a case where the number of counts of the counter within a predetermined time period is relatively very large.

As shown in FIG. 4A, the inter-count spacing for this counter is relatively large, i.e., in view of the number of counts being relatively small per unit of time. Also, at least one count separates each two, consecutive synchronous data blocks. The spacing for the at least one intervening count is therefore relatively large, and amounts to wasted band, i.e., wasted bandwidth. Thus, even with the interval between consecutive synchronous data of respective packets being set to the minimum, the wasted band becomes large. In effect, the counter cannot be set adaptively to the size of data to be transmitted; to the contrary, the incoming synchronous data is positioned according to the inter-count spacings available, thereby wasting bandwidth.

In the case where the number of counts per unit of time is large as shown in FIG. 4B or FIG. 4C, each inter-count interval is small and therefore, the interval between the synchronous data is set to be small. The counter therefore can be set adaptively to the size of each data block, thereby preventing waste of bandwidth. By the same token, however, many counts are processed in reserving a transmission position (that is, many more counts within the same time period are provided in comparison to FIG. 4A). A tradeoff, therefore, is the increase in the processing power utilized in reserving the transmission position.

Considering this, the counting interval is set to be large at a node at which the bandwidth is of importance, and small at a node at which the power is of importance, thereby also increasing system efficiency.

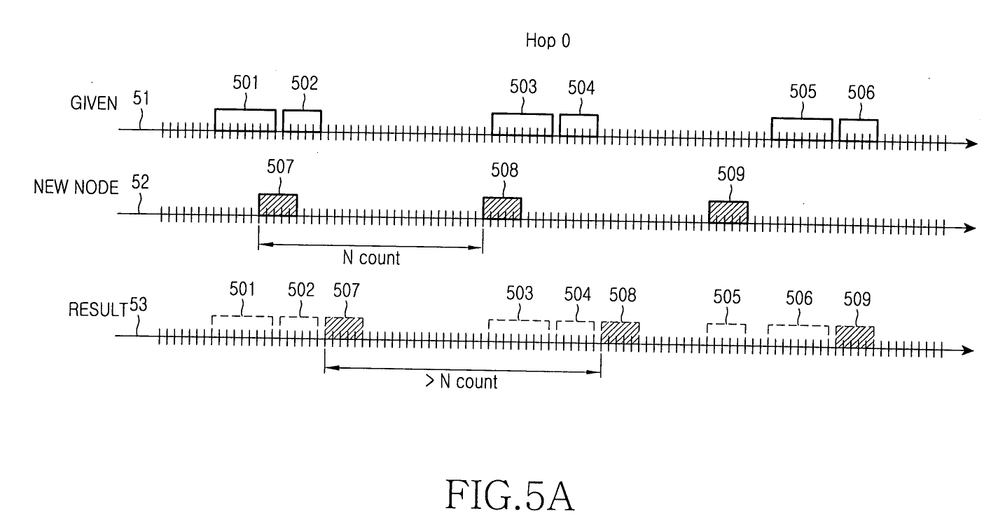

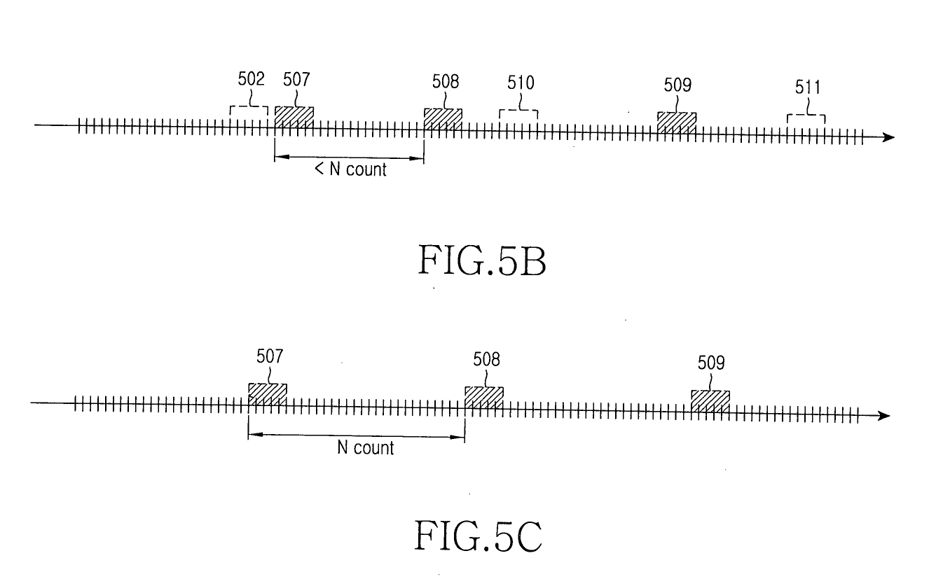

FIG. 5 illustrates an example of reservation of the synchronous data on a node-by-node basis depending on the method for transmitting the synchronous data using the count of the counter in the residential Ethernet system according to an exemplary embodiment of the present invention.

FIG. 5A(a) exemplifies an operation of the multiplexer in case where there exists synchronous data earlier inputted from one node, and a new node connects to the node device 30 and transmits new synchronous data.

In FIG. 5A(a), a reference numeral 51 denotes an example of a transmission position assigned using, as the operating counting scheme, the same counting scheme for the synchronous data earlier inputted from the corresponding node. As shown, the corresponding node currently transmits the synchronous data denoted by reference numerals 501 to 506.

In the case where synchronous data 507 to 509 are inputted from the new node, when transmission from the new node is performed, the inter-node bandwidth reservation process determines the number of counts required to span a size of one-packet synchronous data, and the number of counts between synchronous data of consecutively adjacent packets. Accordingly, the transmission position determined is denoted by a reference numeral 52. The number of intervening counts between packets is exemplified as N. As such, the transmission position of the synchronous data is chosen and such information is transmitted to the multiplexer 35. The multiplexer 35 loads and sends the synchronous data according to the chosen transmission position.

FIG. 5A, refers to the case where another synchronous data portion of a respective one-packet is already transmitted at a Hop 0 of FIG. 5A from a port 51 while new synchronous data is inputted through another port 52. The multiplexer 35 checks and compares, prior to transmission of the new synchronous data, the transmission position of the earlier in-transmission synchronous data with the transmission reservation position of the new synchronous data. The multiplexer 35 then sets and determines the transmission reservation position of the new synchronous data to be in a range where a transmission region of the earlier in-transmission synchronous data is not invaded. Accordingly, in a position 53 different from the transmission reservation position, the new synchronous data 507 to 509 are transmitted. In this case, even the interval between the synchronous data can be made larger than N, the value determined in initial reservation. Preferably, although the new synchronous data 52 is displaced, by synchronous data 51, from initial reservation position, the resulting position 53 tends to keep the new synchronous data close to its initial reservation position.

FIG. 5B exemplifies that the synchronous data 53 of FIG. 5A is transmitted at the lower node of the Hop 0 of FIG. 5A. At the upper node, which is the lower node of a Hop 1, the synchronous data 503 to 506 is eliminated, and the synchronous data 53 of FIG. 5A meets with synchronous data 510 and 511.

In this case, the multiplexer 35 places, at a position most close to the initial reservation position, the synchronous data 52, which were, in the course of transmission on Hop 0, displaced out of their initial reservation position. Thus, to take advantage of the departure of the synchronous data 510 and 511, the initial reservation position for the synchronous data 52 is restored to the extent possible.

In this case, the interval between the synchronous data 507 and 508 is smaller than the earlier set interval (N) and the interval between the synchronous data 508 and 509 is the same as the interval (N).

In the same manner, a transmission position of a Hop 2 of FIG. 5C is determined. If the Hop 2 is an end point, in most cases, a kind of the synchronous data forwarding to the end point is decreased in number. Therefore, a probability of generation of temporary delay of the synchronous data 53 is decreased, and synchronous data transmission based on low jitter is made possible. In this case, the synchronous data transmission based on the same interval and the same position as the reserved position is performed.

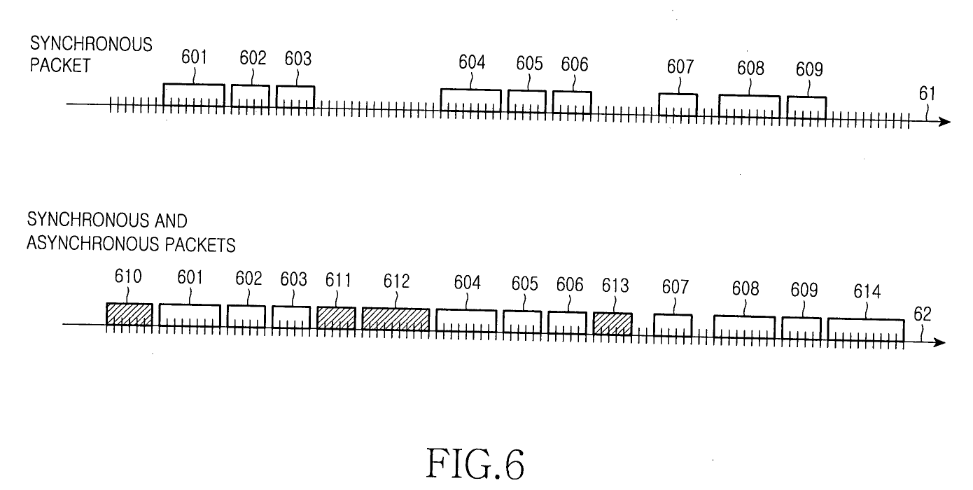

FIG. 6 illustrates a method for integrating asynchronous data into the transmitting of synchronous data using the count of the counter in the residential Ethernet system according to an exemplary embodiment of the present invention.

If the transmission reservation of the synchronous data is performed depending on each counter on a node-by-node basis according to an exemplary embodiment of the present invention, the asynchronous data is multiplexed and transmitted so that it is positioned in remaining regions, i.e., where the synchronous data is not positioned.

In other words, if position reservation for synchronous data 601 to 609 is performed, asynchronous data 610 to 614 are positioned in extra regions, as seen in FIG. 6. Accordingly, invasion on firstly placed synchronous data cannot be performed.

In an exemplary embodiment of the present invention, the hold method, the division method, the hold/division method, the scheduling processing method, and the runt packet method are used in determining the transmission position of the asynchronous data. They are employed so that, in any case, there is no invasion on the position of the synchronous data.

According to the hold method, if the size of the asynchronous data to be transmitted is larger than a region to be transmitted, the asynchronous data is stopped in its transmission and the region to be transmitted is transmitted as empty.

In the division method, if the size of the asynchronous data to be transmitted is larger than the region to be transmitted, the asynchronous data is chopped to have a size of the region to be transmitted and is inserted in the region to be transmitted. A remaining portion of the asynchronous data is transmitted to a next transmission region.

In the hold/division method, when an extent of the region to be transmitted is more than a predetermined critical value, the division method is used, and when less than the critical value, the hold method is used.

The scheduling processing method refers to a method in which, asynchronous data inputted at each destination address are buffered, respectively, and asynchronous data adapted to a size of a transmission duration is searched from each buffer using a scheduling operation. When the asynchronous data is searched, it is compared to the transmission duration. The buffer operates in a first-in-first-out (FIFO) method. Accordingly, in any one buffer, the transmission sequence is preserved.

The runt packet method refers to a method in which, in case where the region to be transmitted is filled before transmission of all asynchronous data, the asynchronous data is again transmitted in a next transmission region at the beginning.

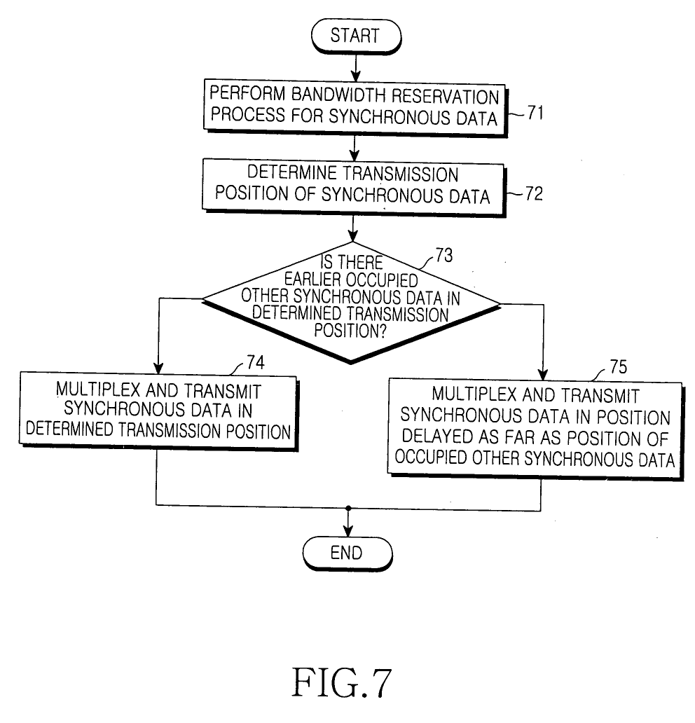

FIG. 7 is a flowchart illustrating a method for transmitting the synchronous data using the count of the counter in the residential Ethernet system according to an exemplary embodiment of the present invention.

Referring to FIG. 7, in the inventive synchronous data transmitting method, the bandwidth reservation process for the synchronous data to be transmitted is performed in each residential Ethernet node device having the set counter (Step 71). In the bandwidth reservation process, the size and the interval of the transmitted synchronous data are determined and informed to all nodes of the residential Ethernet system in order to guarantee a quality of service (QoS) in the residential Ethernet system.

Each residential Ethernet node device accordingly determines the transmission position of the synchronous data that is inputted using the operating counting scheme determined and depending on the clock of the node (Step 72).

If the transmission position is determined as above, the synchronous data is received and multiplexed. In this multiplexing process, it is checked whether or not there are earlier occupied other synchronous data in the determined transmission position (Step 73).

If it is determined that there are not earlier occupied other synchronous data, the synchronous data inputted in the determined transmission position is multiplexed and transmitted (Step 74).

If it is determined that there are earlier occupied other synchronous data, synchronous data inputted in a position delayed as far as a position of the other synchronous data is multiplexed and transmitted (Step 75). As an additional aspect of this step, if it is determined that there are earlier occupied other synchronous data, in case where the synchronous data inputted in the position delayed as far as the position of the other synchronous data is multiplexed and transmitted, when the other synchronous data is eliminated by inter-node movement, the inputted synchronous data is moved to and multiplexed in the determined transmission position.

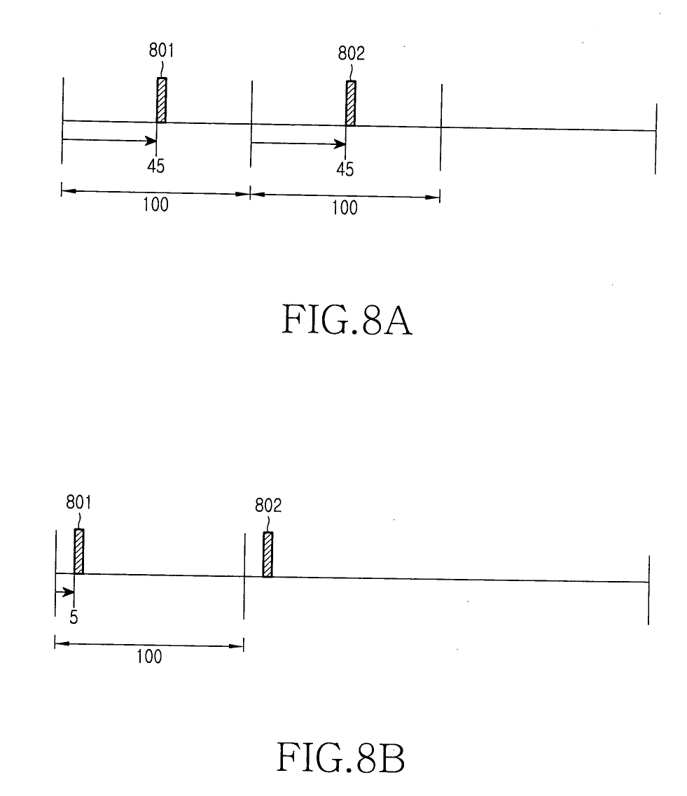

FIGS. 8A and 8B illustrate a method for processing the synchronous data having a small transmission bandwidth in the method for transmitting the synchronous data using the count of the counter in the residential Ethernet system according to an exemplary embodiment of the present invention.

As shown in FIG. 8A, in case the synchronous data with a very small transmission bandwidth such as music data is reserved for transmission in a position 45 of a total transmission interval 100, the synchronous data is not given much weight in its transmission bandwidth but a user suffers from delay as far as the position 45. Accordingly, it is required to process the synchronous data unlike the synchronous data of FIG. 7 according to the present invention.

In the present invention, accordingly, a predetermined critical value is set, and if the synchronous data has a less bandwidth than the predetermined critical value, the synchronous data is multiplexed and positioned in front of the transmission interval with priority over other synchronous data. This is shown in FIG. 8B.

The synchronous data having the small bandwidth such as bandwidths 801 and 802 of FIG. 8A is multiplexed into a position 5, at the front of the transmission interval, not in the reserved position 45.

In the above process, the synchronous data having the small bandwidth can be processed without delay separately from the transmission reservation position.

As described above, the present invention has an effect in that, in embodying the residential Ethernet system, the synchronous data is fixed in position using the counter of each node device itself, i.e., beyond a restriction of the limited and regularized transmission duration that is a traditional cycle. Complex processes necessary for accepting the synchronous data within a duration of one cycle are thereby simplified.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A residential Ethernet node device for transmitting synchronous data using a counter in a residential Ethernet system, the device comprising:
a parser for receiving residential Ethernet data from other node devices in said system, and parsing the received Ethernet data into synchronous data and asynchronous data;
an asynchronous switch for switching and transmitting the parsed asynchronous data;
a synchronous switch for switching and transmitting the parsed synchronous data;
a multiplexer for receiving and multiplexing the parsed asynchronous and synchronous data; and
a synchronous data band assignment unit for, by the counter, indicating synchronous data bandwidth information determined from a synchronous data bandwidth reservation process, and transmitting the indicated bandwidth information to the multiplexer, said multiplexer being configured for, based on the received bandwidth information, determining a multiplex position for synchronous data transmission.

2. The device of claim 1, wherein the counter is configured for equally dividing a transmission band of a predetermined time interval in “N” equal parts, said multiplexer being configured for using the counter for the determining of said multiplex position for synchronous data transmission.

3. The device of claim 2, wherein, in case where the residential Ethernet data received from a device from among said other node devices comprises a control signal, the parser parses and outputs the control signal, and further comprising a control module for transmitting the outputted control signal to the multiplexer.

4. The device of claim 2, wherein the synchronous data bandwidth information indicates a size of a transmission unit of the synchronous data and a transmission interval between the synchronous data, both the size and interval being conveyed, in the synchronous data bandwidth information, in terms of counts of a counter of a corresponding node.

5. The device of claim 4, wherein the multiplexer sets a critical value of the bandwidth for the synchronous data, and multiplexes and positions synchronous data having a smaller critical value than the critical value of the bandwidth, in front of the transmission interval despite the determined position.

6. The device of claim 2, wherein a counting interval of the counter is set to be larger than a predetermined critical value at an upper node of a given hop at which a bandwidth is of importance, and is set to be smaller than a predetermined critical value at a lower node of said hop at which a processing power is of importance.

7. The device of claim 2, wherein the multiplexer first positions the synchronous data, positions the asynchronous data using a region where the positioned synchronous data does not exist, and multiplexes the asynchronous data and the synchronous data.

8. The device of claim 7, wherein the multiplexer positions and multiplexes the asynchronous data using the region where the positioned synchronous data does not exist, by selecting from among a hold method, a division method, a hold/division method, a scheduling processing method, and a runt packet method.

9. The device of claim 1, wherein the multiplexer first positions the synchronous data, positions the asynchronous data using a region where the positioned synchronous data does not exist, and multiplexes the asynchronous data and the synchronous data.

10. The device of claim 1, wherein, in case where the residential Ethernet data received from a device from among said other node devices comprises a control signal, the parser parses and outputs the control signal, and further comprising a control module for transmitting the outputted control signal to the multiplexer.

11. The device of claim 1, wherein the synchronous data bandwidth information indicates a size of a transmission unit of the synchronous data and a transmission interval between the synchronous data, both the size and interval being conveyed, in the synchronous data bandwidth information, in terms of counts of a counter of a corresponding node.

12. The device of claim 1, wherein a counting interval of the counter is set to be larger than a predetermined critical value at an upper node of a given hop at which a bandwidth is of importance, and is set to be smaller than a predetermined critical value at a lower node of said hop at which a processing power is of importance.

13. A method for transmitting synchronous data using counts of a counter in a residential Ethernet node device of a residential Ethernet system, the method comprising:
a first step of performing a bandwidth reservation process for the synchronous data to be transmitted, for the residential Ethernet node device having the counter;
a second step of determining a transmission position of the synchronous data that is inputted using the counter in the residential Ethernet node device;
a third step of, upon determination of the transmission position, checking whether or not there are earlier occupied other synchronous data in the determined transmission position;
a fourth step of, if it is determined that there are the earlier occupied other synchronous data, transmitting the inputted synchronous data in a position delayed as much as a position of the other synchronous data; and
a fifth step of, if it is checked as the check result that there are not the earlier occupied other synchronous data, transmitting the inputted synchronous data in the determined transmission position.

14. The method of claim 13, wherein the counter is configured for equally dividing a transmission band of a predetermined time interval in N equal parts, said multiplexer being configured for using the counter for the determining of said transmission position of the synchronous data.

15. The method of claim 14, wherein in the fourth step, in case where the earlier occupied synchronous data delaying the synchronous data is eliminated, the synchronous data multiplexed and transmitted in the delayed position is moved to and multiplexed in the determined transmission position.

16. The method of claim 14, further comprising a sixth step of: after the position of the synchronous data is determined in the fifth step, multiplexing and positioning the asynchronous data in the region where the synchronous data does not exist, and transmitting the synchronous data and the asynchronous data together.

17. The method of claim 16, wherein, in the sixth step any one of a hold method, a division method, a hold/division method, a scheduling processing method, and a runt packet method is used to position and multiplex the asynchronous data in the region where the synchronous data does not exist, so that the asynchronous data is not damaged.

18. The method of claim 14, further comprising:
a sixth step of setting a critical value of a bandwidth for the synchronous data; and
a seventh step of multiplexing and positioning synchronous data having a smaller critical value than the critical value of the bandwidth, in front of the transmission interval despite the position determined in the fourth and fifth steps.

19. The method of claim 13, further comprising a sixth step of: after the position of the synchronous data is determined in the fifth step, multiplexing and positioning the asynchronous data in the region where the synchronous data does not exist, and transmitting the synchronous data and the asynchronous data together.
